(19) United States
(12) Patent Application Publication
(10) Pub. No.: US 2026/0026419 A1
(43) Pub. Date: Jan. 29, 2026

(54) HARROW WITH DIFFERENT TINE SIZES

(71) Applicant: Schulte Industries Ltd., Saskatoon (CA)

(72) Inventors: Todd Hofmann, Saskatoon (CA); Bruno Jair Jacobo Moncayo, Saskatoon (CA)

(21) Appl. No.: 18/781,593

(22) Filed: Jul. 23, 2024

(51) Int. Cl. A01B 23/00; A01B 19/04; A01B 19/10; A01B 35/06; A01B 35/24

(52) U.S. Cl. CPC A01B 23/00; A01B 19/04; A01B 19/10; A01B 35/06; A01B 35/24

(57) ABSTRACT

A harrow apparatus is provided. The harrow apparatus can have a main frame mounted on ground wheels for travel along a ground surface in a travel direction, a hitch assembly attached to a front end of the main frame and operative to connect to a tow vehicle, and a harrow section connected rearwardly of the main frame, the harrow section having a plurality of tines extending downwards to engage with the ground surface. The plurality of tines can include a first set of tines having a first diameter, and a second set of tines having a second diameter. The first diameter of the first set of tines is larger than the second diameter of the second set of tines.

The present invention relates to a harrow and more specifically a tine harrow with different sized tines.

### BACKGROUND

A harrow is an agricultural implement used to till the surface of a field to break up and smooth the surface of the soil. A tine harrow is a particular type of harrow that uses steel “tines” that are pulled through the soil surface. The tine harrow is typically used to refine the seed bed condition in a field and to prepare a field for seeding a crop. Tine harrows can also be used to control weeds in growing crops and loosen the soil between crop rows to allow water to better soak into the field.

Tine harrows typically have a number of rows of “tines” that extend downwards so that the bottom ends of these tines are dragged through the soil surface. The size of the tines on a tine harrow will typically be chosen depending based on the intended purpose of the tine harrow, because different diameter tines will have different advantages. Tines with larger diameters will typically deflect less as the tine harrow is pulled through a field. This causes larger diameter tines to be more aggressive; more easily breaking up the soil and residue, such as straw, left in the field. Tines with smaller diameters can deflect more and have more “spring”. While smaller diameter tines may not break up the soil and reside as well as larger diameter tines, their springiness can better spread out the soil; providing better soil distribution and “field finish”. Typically, there is a trade-off between a more aggressive tine harrow with larger tines, which is better for breaking up the soil, and a tine harrow with smaller tines, which is better for finishing a field.

Additionally, tines at the front of a tine harrow will typically wear faster than the tines at the back of the tine harrow because the tines in the front will typically pass through the soil first, requiring more force to break up this soil than the tines at the back that are passing through the soil after the front tines have already passed through it. This can subject the front tines to more abrasion because of the increased force on these front tines to “open up” the soil before the tines further back on the implement pass through the already “opened up” soil, causing these front tines to wear faster than the tines further back on the tine harrow.

### SUMMARY OF THE INVENTION

In an aspect, a harrow apparatus is provided. The harrow apparatus has a main frame mounted on ground wheels for travel along a ground surface in a travel direction, a hitch assembly attached to a front end of the main frame and operative to connect to a tow vehicle, and a harrow section connected rearwardly of the main frame, the harrow section having a plurality of tines extending downwards to engage with the ground surface. The plurality of tines include a first set of tines having a first diameter, and a second set of tines having a second diameter. The first diameter of the first set of tines is larger than the second diameter of the second set of tines.

### DESCRIPTION OF THE DRAWINGS

A preferred embodiment of the present invention is described below with reference to the accompanying drawings, in which:

FIG. 1 is a perspective view of a harrow apparatus;

FIG. 2 is a side view of the harrow apparatus shown in FIG. 1;

FIG. 3 is a perspective view of a tool frame supporting a plurality of rows of tines;

FIG. 4 is a side view of the tool frame shown in FIG. 3;

FIG. 5 is a front view of the tool frame shown in FIG. 3;

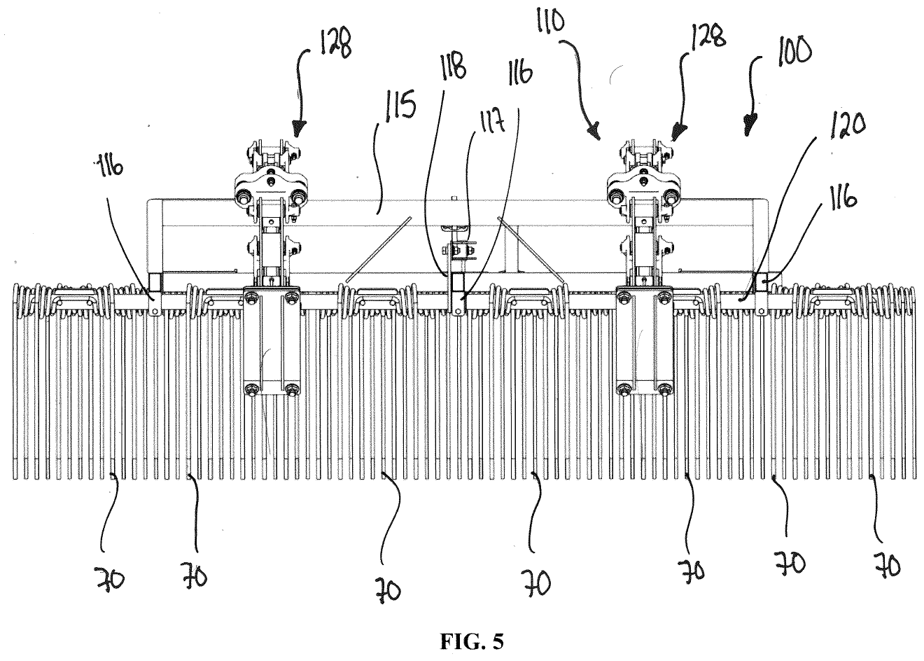

FIG. 6 is a perspective view of a harrow tine assembly; and

FIG. 7 is a perspective view of a plurality of harrow tine assemblies installed on a harrow tube.

### DETAILED DESCRIPTION OF THE ILLUSTRATED EMBODIMENTS

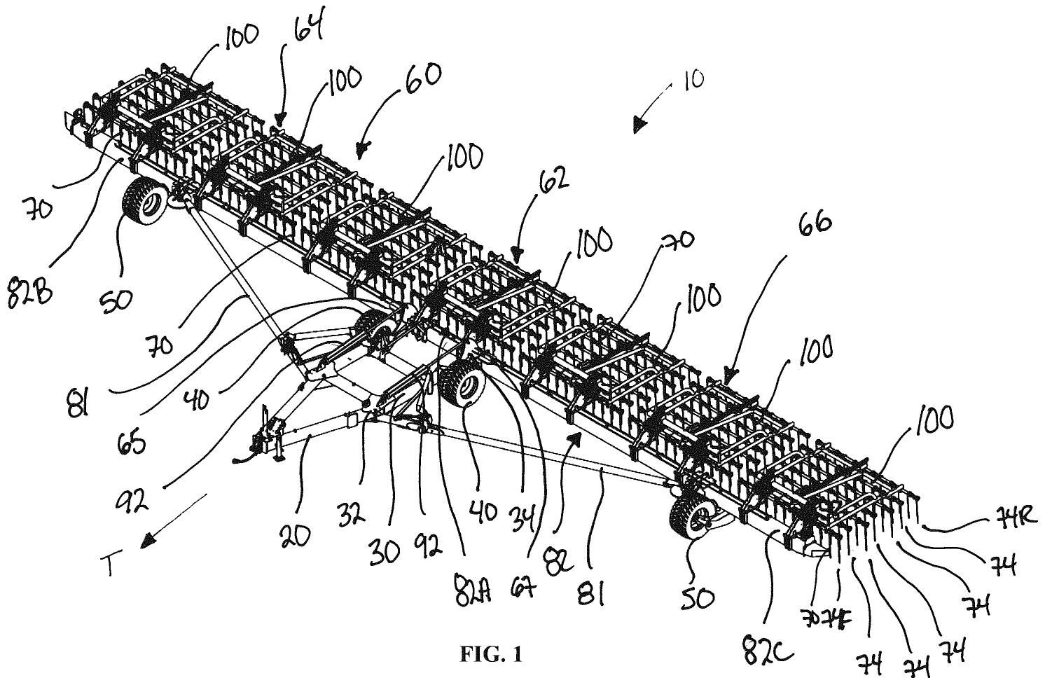

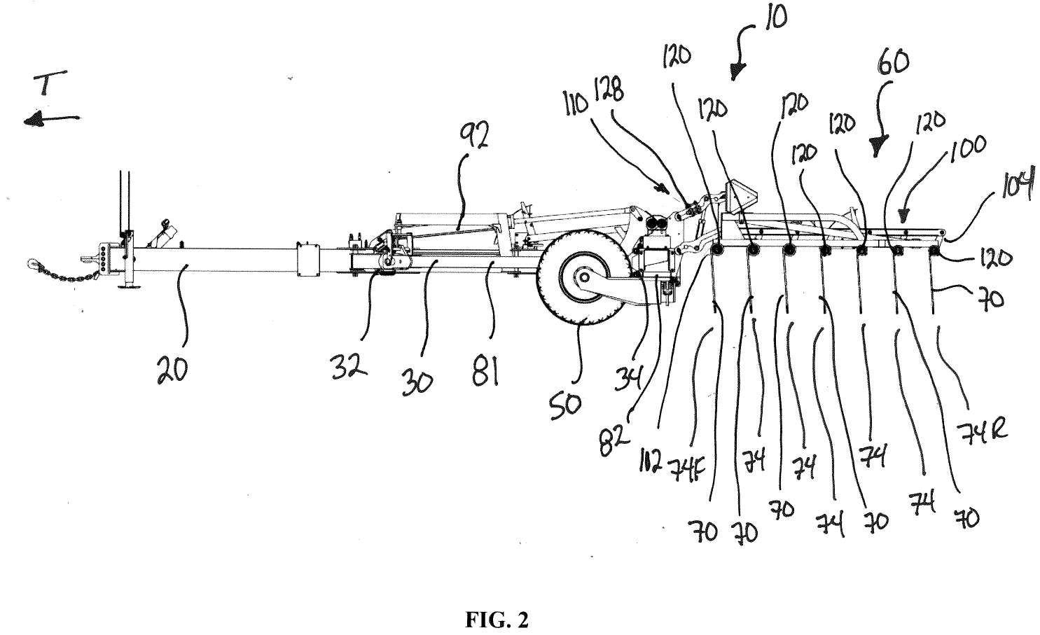

FIGS. 1 and 2 illustrates a harrow apparatus 10 to be pulled by a tow vehicle, such as a tractor, (not shown) through a field in an operating travel direction T. The harrow apparatus 10 can include a hitch assembly 20; a main frame 30, main ground wheels 40, wing ground wheels 50; a harrow section 60 with a plurality of rows 74 of tines 70.

The hitch assembly 20 can be connected to a front end 32 of the main frame 30 and connectable to a tow vehicle, such as a tractor (not shown), so that the harrow apparatus 10 can be connected to the tow vehicle and towed across a field in a travel direction T.

The main frame 30 can be supported above the ground surface by the main ground wheels 40 that are mounted on the main frame 30 and the harrow section 60 can be pivotally connected to a rear end 34 of the main frame 30 and extend rearward from the main frame 30 when the harrow section 60 is in an operating position.

The harrow section 60 can comprise a plurality of rows 74 of tines 70 and the rows 74 of tines 74 can be spaced rearwardly from a front row 74F of tines 70 to a rear row 74R of tines 70. Each row 74 of tines 70 can be oriented substantially perpendicular to the operating travel direction T when the harrow apparatus 10 is in an operating position.

The harrow section 60 can be comprised of one or more sections, but in the harrow apparatus 10 shown in FIGS. 1 and 2, the harrow section 60 can have a middle section 62, a first wing section 64 and a second wing section 66. The middle section 62 of the harrow section 60 can be pivotally attached to the rear end 34 of the main frame 30. The first wing section 64 can be pivotally attached at first pivot connection 65 to a first side of the middle section 62 and the second wing section 66 can be pivotally attached at second pivot connection 67 to a second side of the middle section 62.

Folding actuators 92, such as hydraulic cylinders, can be provided between the main frame 30 and the harrow section 60, specifically the middle section 62, to pivot the harrow section 60 from an operating position, with the harrow section 60 extending substantially horizontally and the tines 70 extending downwards into the soil, as shown in FIGS. 1 and 2, upwards to a vertical position. Locking members 81, holding the first wing section 64 and the second wing section 66 perpendicular to the travel direction T can be disconnected and, with the harrow section 60 in the vertical position, the harrow apparatus 10 can be pulled forward, pivoting the first wing section 64 and the second wing section 66, rearward, around the first pivotal connection 65 and the second pivotal connection 67, respectively, until the first wing section 64 and the second wing section 66 are substantially parallel to the travel direction T. The wing ground wheels 50 can then be pivoted to be oriented in the travel direction T placing the harrow apparatus 10 in a transport position.

The harrow apparatus 10 can be transformed back from the transport position to the operating position, by backing up the harrow apparatus 10, pivoting the first wing section 64 and the second wing section 66, around the first pivotal connection 65 and the second pivotal connection 67, respectively, until the first wing section 64 and the second wing section 66 are once again substantially perpendicular to the travel direction T. The locking members 81 can be reconnected to the first wing section 64 and the second wing section 66 to once lock the first wing section 64 and the second wing section 66 substantially perpendicular to the travel direction T and the wing ground wheels 50 pivoted to be oriented in the travel direction T. The harrow section 60 can then be pivoted downwards by the folding actuators 92 until the harrow section 60 is substantially horizontal, placing the harrow apparatus 10 back into the operating position.

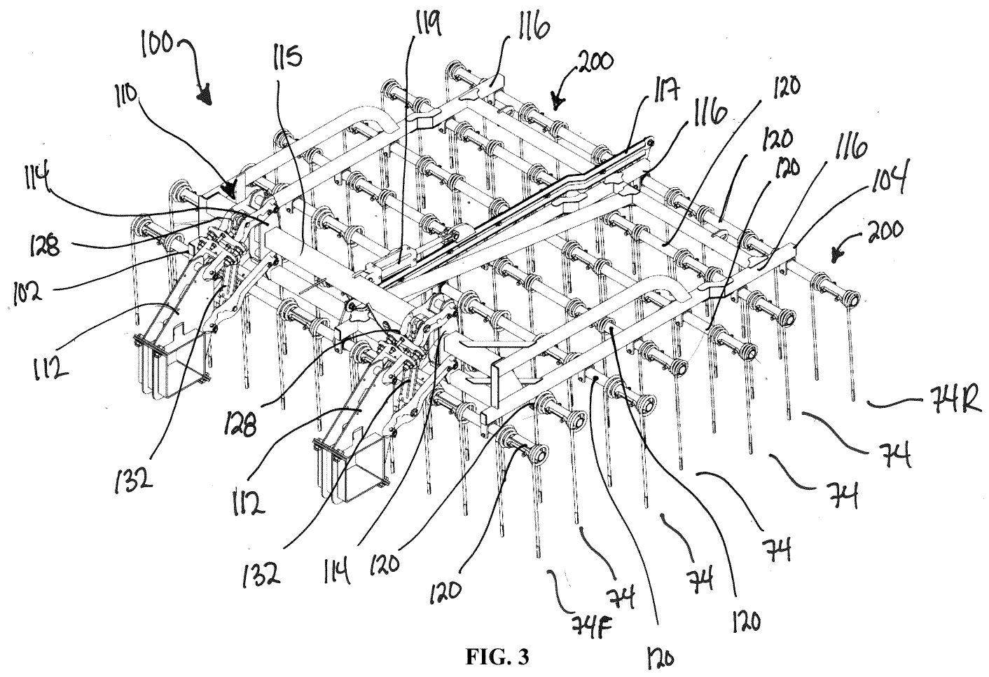

Referring to FIG. 3, one of the tool frames 100 is shown. Referring to FIGS. 1-3, the tool frame 100 can attached to a tool beam 82 by a mounting assembly 110 that extends rearward from the tool beam 82 and allows the tool frame 100 to be movable upwards and downward with respect to the tool beam 82. The tool beam 82 can be pivotally attached to the rear end 34 of the main frame 30, as shown in FIG. 2, causing the tool frame 100 to be movable upwards and downwards relative to the main frame 30, as well, when the harrow section 60 is in the operating position.

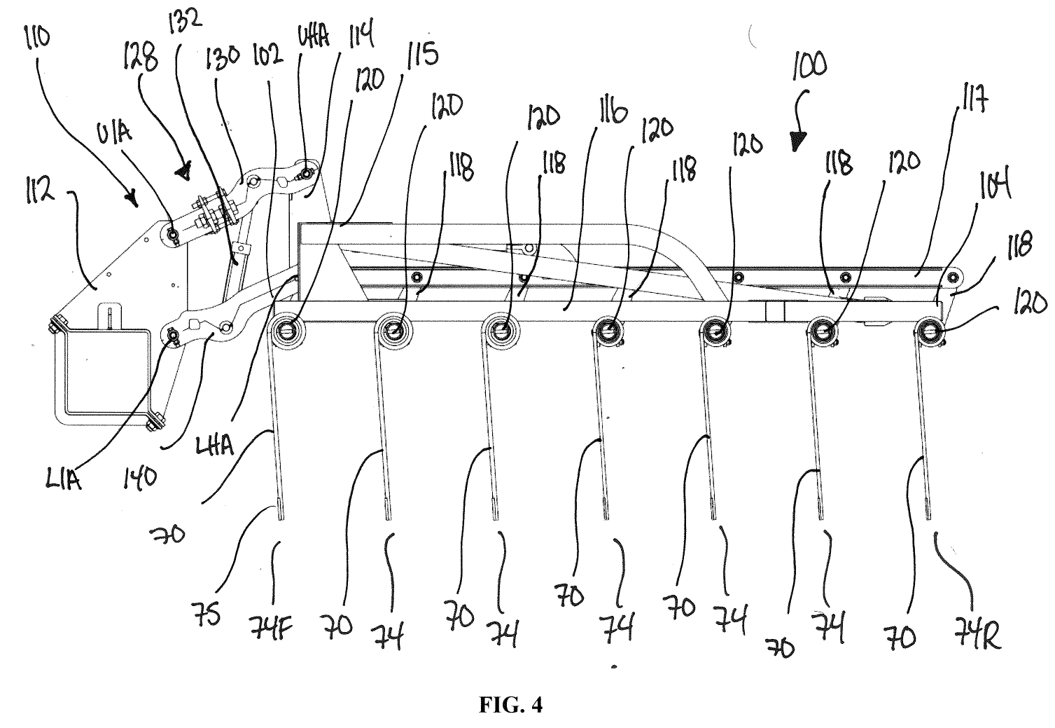

Referring to FIG. 3, a plurality of harrow tubes 120 can provided on the bottom of the tool frame 100, extending perpendicular to the travel direction T of the harrow apparatus 10. Referring to FIG. 4, tines 70 can extend downwards from the tool frame 100 and the harrow tubes 120 to engage with the surface of the soil.

Referring to FIGS. 3 and 4, the mounting assembly 110 can have mounting brackets 112 attachable to the tool beam 82. In one aspect, the tool beam 82 can have a middle tool beam 82A, a first wing tool beam 82B, and a second wing tool 82C AS shown in FIG. 1. The middle section 62 of the harrow section 60 can be defined by the middle tool beam 82A, the first wing section 64 of the harrow section 60 can be defined by the first wing tool beam 82B, and the second wing section 66 of the harrow section 60 can be defined by the second wing tool beam 82C. A first end of the middle tool beam 82A and an end of the first wing tool beam 82B can be connected by the first pivotal connection 65 and a second end of the middle tool beam 82A and an end of the second wing tool beam 82C can be connected by the second pivotal connection 67.

The mounting assembly 110 can have a parallel linkage 128 with an upper link 130 and a lower link 140 pivotally attached between the mounting bracket 112 that is attached to the main frame 30 and a harrow bracket 114 that is attached to the tool frame 100. A front end of the upper link 130 can be pivotally attached to the mounting bracket 110 at pivot axis UIA and the front end of the lower link 140 can be pivotally attached to the mounting bracket 112 at pivot axis LIA. The rear end of the upper link 30 can be pivotally attached to the harrow bracket 114 at an upper harrow pivot axis UHA and the rear end of the lower link 40 can be pivotally attached to the harrow bracket 114 at a lower harrow pivot axis LHA.

The mounting assembly 110 can have an extendable actuator 132, such as a hydraulic cylinder, pivotally attached to the parallel linkage 128. The extendable actuator 132 can be pivotally attached to the upper link 130 at an upper actuator location UAL and pivotally attached to the lower link 140 at a lower actuator location LAL that is offset from the UAL so that extending and retracting the extendable actuator 132 is operative to raise and lower the tool frame 100.

In addition to raising and lowering the tool frame 100, the force the extendable actuator 132 applies to the upper link 130 and the lower link 140 can be used to vary the downward force of the tool frame 100 on the tines 70 and therefore the soil. With the extendable actuator 132 applying no force to the upper link 130 and the lower link 140, the tool frame 100 can “float”, with the weight of the tool frame 100 acting on the tines 70 and forcing the tines 70 into the ground surface. However, by increasing the force the extendable actuator 132 is applying to the upper link 130 and the lower link 140, the weight of the tool frame 100 and tines 70 can be counteracted and the force applied to the ground surface can be reduced. As enough force is applied by the extendable actuator 132 to the upper link 130 and the lower link 140, the tool frame 100 and the tines 70 will be raised above the ground surface.

Referring to FIGS. 3 and 4, the mounting assembly 110 can include a mounting frame 115 with mounting beams 116. The mounting frame 115 can be attached to the harrow bracket 114, with the mounting beams 116 extending rearward from the mounting frame 115. Harrow tubes 120 can be attached below the mounting beams 116 with the harrow tubes 120 extending substantially perpendicular to the travel direction T of the harrow apparatus 10 when the harrow apparatus 10 is in the operating position.

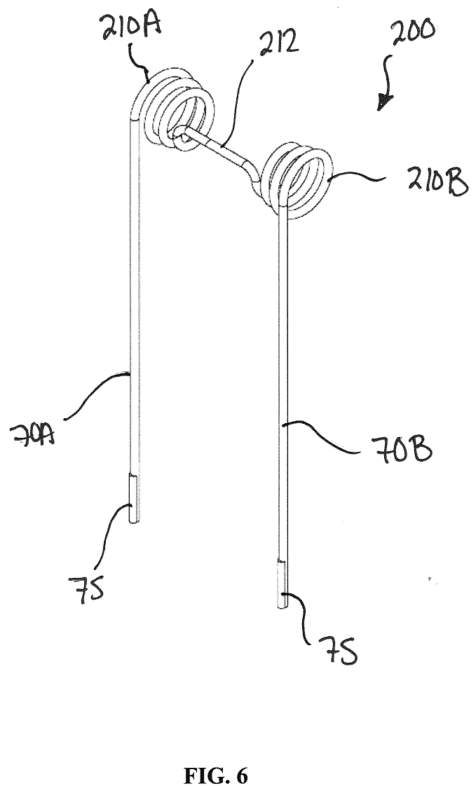

Harrow tine assemblies 200 can be provide on the harrow tubes 120. Referring to FIG. 6, each harrow tine assembly 200 can be made of spring steel and have a pair of tines 70A, 70B. Each tine 70A, 70B, can be connected to a coil spring 210A, 210B, respectively, with a connection member 212 connecting the coil springs 210A, 210B. Optionally, a wear tip 75 can be affixed to the front of each tine 70A, 70B, at a bottom end of the tine 70A, 70B, where the tine 70A, 70B will pass through the soil, to reduce wear of the tine 70A, 70B.

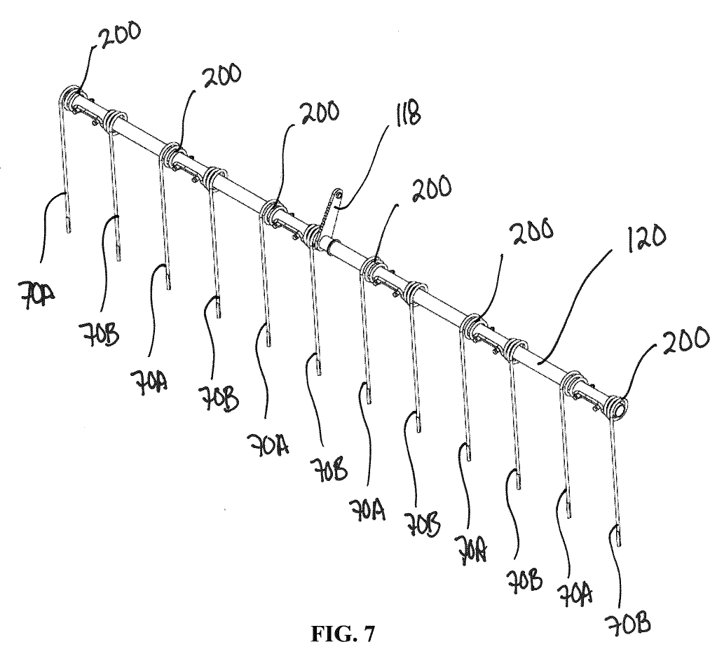

The coil springs 210A, 210B can form a aperture passing therethrough, through which the harrow tube 120 can pass, allowing the tine assembly 200 to be mounted on the harrow tubes 120, as shown in FIG. 7. The connection member 212 can be secured relative to the harrow tube 120 so that the connection member 212, and therefore the harrow tine assembly 200, is fixed relative to the harrow tube 120, with the harrow tine assembly 200 unable to rotate around the harrow tube 120.

The harrow tine assemblies 200 can be attached on the harrow tubes 120 with the tines 70A, 70B extending downwards from the harrow tubes 120 and the tool frame 100. All of the harrow tine assemblies 200 attached to one of the harrow tubes 120 will form a row 74 of tines 70.

When the tines 70A, 70B of a harrow tine assembly 200 are dragged through a soil surface, the coil springs 210A, 210B allow the harrow tines 70A, 70B to deflect backwards, if the bottom ends of the tines 70A, 70B comes into contact with a rock or some other obstacle it cannot pass through, the coil springs 210A, 210B can be placed in torsion, allowing the tines 70A, 70B to deflect backwards, and when the obstacle is cleared, the coil springs 210A, 210B can bias the tines 70A, 70B forwards to their original positions.

Referring again to FIGS. 3 and 4, the harrow tubes 120 can be rotatably connected to the mounting beams 116 so that the harrow tubes 120 can rotate relative to the mounting beams 116. Referring to FIG. 4, a biasing beam 117 can be provided pivotally connected to a series of links 118 with each link 118 pivotally connected at one end to the biasing beam 117 and fixedly attached (non-pivotally) to one of the harrow tubes 120. Referring against to FIGS. 3 and 4, a tine actuator 119, such as a hydraulic cylinder, can be provided connected between the harrow bracket 114 and the biasing beam 117. When the tine actuator 119 is extended, the biasing beam 117 will be moved rearward along with the first ends of the links 118. This will cause the second ends of the links 118 to pivot the harrow tube 120 that the second end of each link 118 is connected to. Moving the biasing beam 117 rearward will place more biasing force on the tines 70, increasing the forward force of the tines 70 into the soil. Moving the biasing beam 117 forwards will decrease the biasing force on the tines 70, decreasing the forward force of the tines 70 into the soil.

Referring to FIG. 4, the harrow tubes 120 can be positioned so that the harrow tubes 120 are spaced horizontally from the front end 102 of the tool frame 100 to a rear end 104 of the tool frame 100, thereby causing all of the tines 70 attached to one of the harrow tubes 120 to form a row 74 of tines 70. With rows 74 of tines 70 spaced horizontally from the front end 102 of the tool frame 100, starting with the front row 74F, to the back end 104 of the tool frame 100, ending with the rear row 74R of tines 70.

Rather than all of the tines 70 in all of the rows 74 of tines 70 in the harrow section 60 having the same size (i.e. diameter or thickness of the tine), the tines 70 in the harrow section 60 can have different diameters. Tines 70 with a larger diameter are less flexible and can better break up hard soil, while tines with smaller diameters can be more flexible, spreading the soil better and leaving a better finished field. Additionally, Tines 70 with smaller diameters will wear out faster from abrasion than tines 70 with larger diameters because the tines 70 with larger diameters will have more material to be worn away. By using both larger diameter tines 70 and smaller diameter tines 70 in the same harrow section 60 and in the same tool section 100, the harrow apparatus 10 can achieve the advantages of both larger diameter tines and smaller diameter tines.

Each tool frame 100 in the harrow section 60 can have a first set of tines 70 having a first diameter and a second set of tines 70 having a second diameter, with the first diameter being larger than the second diameter. In one aspect, the first diameter could be ⅝″ and the second diameter could be ½″.

In another aspect, in addition to a first set of tines 70 having a first diameter and a second set of tines 70 have a second diameter, a third set of tines 70 having a third diameter can also be provided. The third diameter can be smaller than the first diameter and larger than the second diameter. In one aspect, the third diameter could be 9/16″.

In one aspect, more than three sets of tines 70 with each set having a different diameter could be used.

In one aspect, there may be no pattern with how the first set of tines 70 and the second set of tines 70 are provided on the tool frame 100 and the harrow section 60. If a third set of tines 70 is used, there may also be no pattern with how this third set of tines 70 is positioned relative to the first set of tines 70 and the second set of tines 70.

In another aspect, the first set of tines 70 can include the tines in the front row 74F of tines 70 of the tool frame 100 and the second set of tines 70 can include the rear row 74R of tines 70 of the tool frame 100. The tines 70 in the first row 74F at the front end 102 of the tool frame 100 will typically come into contact with the soil surface first and break up the soil before the tines 70 at the rear end 104 of the tool frame 100 in the rear row 74F pass through the broken-up soil; improving the dispersion of the already worked soil. The tines 70 that are first contacting the soil are typically subjected to higher force as a result of being the tines 70 to first break up the soil. This increased force can case these tines 70 to wear faster than the tines 70 in the rear end 104 of the tool frame 100, that pass through the soil that has already been worked by the front tines 70.

In addition to first set of tines 70 including the tines 70 making up the front row 74F, the first set of tines 70 having the first diameter can include the tines 70 in one or more of the rows 74 extending rearward from the front row 74F and the second set of tines 70 can include the tines 70 in the rear row 74R and the tines 70 in one or more rows extending forward from the rear row 74R.

For example, referring to FIG. 4, the front row 74F of tines 70 and the second and third row 74 could make up the first set of tines 70 having the first diameter and the rear row 74R of tines 70 and the three rows 74 in front of the rear row 74 could make up the second set of tines 70 have the second diameter. However, this is just exemplary and more rows could either make up the first set of tines 70 or the second set of tines 70.

If a third set of tines 70 is used, the third set of tines 70 could be provided in a row 74 or rows 74 in between the rows 74 with the first set of tines 70 and the rows 74 with the second set of tines 70.

In another aspect, referring to FIGS. 3 and 4, the tines 70 in the front portion (or even the front half) of the tool frame 100 will not necessarily be all of the tines 70 that are first coming into contact with the unbroken soil. As the harrow apparatus 10 is pulled through a field in the travel direction T, each tine 70 will follow a path through the field in the travel direction T passing through the soil in this path. The paths followed by a forward set of tines 70 will cause these tines 70 to be the first tines 70 on the tool frame 100 to come into contact with the soil in the field; breaking up the soil. A rearward set of tines 70 positioned rearward of the forward set of tines 70 will also follow paths through the field in the travel direction T passing through the soil in these paths and these paths can be the same or close to the paths followed by the forward set of tines 70. Because the paths of the rearward set of tines 70 are the same or close to the paths of the forward set of tines 70, the soil has already been passed through by the forward set of tines 70, with the result that the rearward set of tines 70 are passing through soil that has already been loosened by the forward set of tines 70 passing through the soil. The forward set of tines 70 can have a first diameter and the rearward set of tines 70 can have a second diameter with the first diameter being larger than the second diameter.

All of the forward set of tines 70 do not have to be in the forward half of the tool frame 100, but rather could be in any of the rows 74 forward from the rear row 74R if the tines 70 in the rear row 74R closely follow the path of the forward tines 70.

In a further aspect, the tines 70 having larger diameters can have a shorter length than the tines 70 having smaller diameters. The tines 70 with larger diameters will deflect less than tines 70 made of the same material with smaller diameters because the smaller diameter allows the tine 70 to bend more than the tines 70 having larger diameters. When the extendable actuator 132 is set to not place any force on the upper link 130 and the lower link 140 of the parallel linkage 128, causing the tool frame 100 to float with the weight of the tool frame 100 acting on the tines 70 and forcing the tines 70 into the soil surface, the tines 70 will support the weight of the tool frame 100. However, in some cases, the smaller diameter tines 70 may deflect more than the larger diameter tines 70. This can cause the tool frame 100 to not sit level as the harrow apparatus 10 is pulled through a field. This can be exacerbated if the tines 70 in the front end 102 of the tool frame 100 all have larger diameters than the tines 70 at the rear end 104 of the tool frame 100. If the smaller diameter tines 70 deflect more, the front end 102 of the tool frame 100 can ride higher than the rear end 104 of the tool frame 104, if the length of the tines 70 are all the same. By having the tines 70 with the smaller diameters also having a longer length, the extra length can compensate for their greater deflection, allowing the tool frame 100 to ride more level.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A harrow apparatus comprising:
a main frame mounted on ground wheels for travel along a ground surface in a travel direction;
a hitch assembly attached to a front end of the main frame and operative to connect to a tow vehicle; and
a harrow section connected rearwardly of the main frame, the harrow section having a plurality of tines extending downwards to engage with the ground surface, the plurality of tines comprising: a first set of tines having a first diameter; and, a second set of tines having a second diameter,
wherein the first diameter of the first set of tines is larger than the second diameter of the second set of tines.

2. The harrow apparatus of claim 1 wherein the plurality of tines are arranged into a plurality of rows, the rows spaced rearwardly from a front row to a rear row, each row oriented substantially perpendicular to the travel direction when the apparatus is in an operating position.

3. The apparatus of claim 2 wherein the first set of tines includes the tines in the front row and the second set of tines includes the tines in the rear row.

4. The harrow apparatus of claim 3 wherein the first set of tines includes the tines in one or more rows extending rearward from the front row, and wherein the second set of times includes the tines in one or more rows extending forward from the rear row.

5. The harrow apparatus of claim 1 wherein the second set of tines correspond to a rearward set of tines, the rearward set of tines following a path that passes through soil that a forward set of tines has broken up.

6. The harrow apparatus of claim 5 wherein the first set of tine comprises the forward set of tines.

7. The harrow apparatus of claim 1 wherein the plurality of tines further comprises a third set of tines having a third diameter, wherein the third diameter is smaller than first diameter and larger than the second diameter.

8. The harrow apparatus of claim 1 wherein the harrow section comprises two or more tool frames.

9. The harrow apparatus of claim 8 wherein each tool frame is pivotally connected to a tool beam attached to the rear end of the main frame by a mounting assembly, the mounting assembly operative to allow the tool frame to move upwards and downwards relative to the main frame.

10. The harrow apparatus of claim 9 wherein the mounting assembly comprises: a mounting bracket attached to the tool beam; a harrow bracket attached to the tool frame; and, a parallel linkage comprising: an upper link; and, a lower link, the parallel linkage connected between the mounting bracket and the harrow bracket.

11. The harrow apparatus of claim 10 wherein the upper link is pivotally connected at a front end of the upper link to the mounting bracket and the rear end of the upper link is pivotally connected at a rear end of the upper link to the harrow bracket, and wherein the lower link is pivotally connected at a front end of the lower link to the mounting bracket and pivotally connected at a rear end of the lower link to the harrow bracket.

12. The harrow apparatus of claim 11 further comprising an extendable actuator extending between the upper link at an upper actuator location and the lower link at a lower actuator location, wherein the upper actuator location is offset from the lower actuator location.

13. The harrow apparatus of claim 10 further comprising: a mounting frame attached to the harrow bracket; and mounting beams extending rearward from the mounting frame.

14. The harrow apparatus of claim 13 further comprising a plurality of harrow tubes attached below the mounting beams and extending substantially perpendicular to the travel direction, wherein the plurality of tines extend downwards form the plurality of harrow tubes.

15. The harrow apparatus of claim 14 further comprising harrow tine assemblies, each harrow tine assembly comprising: a pair of tines; a pair of coil spring connected to each tine; and a connection member connecting the pair of coil springs.

16. The harrow apparatus of claim 15 wherein the pair of coil springs forming an aperture to allow one of the harrow tubes to pass through the aperture.

17. The harrow apparatus of claim 1 wherein the harrow section is pivotally attached to the rear end of the main frame and extends rearward from the main frame when the harrow section is in an operating position.

18. The harrow apparatus of claim 17 wherein the harrow section has a middle section pivotally attached to the rear end of the main frame, a first wing section pivotally attached to a first side of the middle section, and a second wing section pivotally attached a second side of the middle section, wherein the middle section can be pivoted upwards, from an operating position, around the rear end of the main frame, the first wing section can be pivoted around the first side of the middle section, and the second wing section can be pivoted around the second side of the middle section to place the harrow apparatus in a transport position.

19. The barrow apparatus of claim 18 further comprising at least one a folding actuator connected between the main frame and the middle section to pivot the middle section around the rear end of the main frame.
